(19) United States
(12) Patent Application Publication
(10) Pub. No.: US 2007/0041604 A1
(43) Pub. Date: Feb. 22, 2007

(54) EARPHONE

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,854

(22) Filed: Sep. 26, 2005

(30) Foreign Application Priority Data
Aug. 17, 2005 (TW) 94127990

(51) Int. Cl. H04R 25/00

(52) U.S. Cl. 381/370

(57) ABSTRACT

An earphone comprising a body, a wire-holder and an electric wire is provided. The body has a first pivoting part and the wire-holder has a second pivoting part. The electric wire passes smoothly through the wire-holder and is electrically connected to the body of the earphone. The second pivoting part is pivoted to the first pivoting part so that the wire-holder can be rotated with reference to the body.

### CROSS-REFERENCE TO RELATED APPLICATION

This application claims the priority benefit of Taiwan application serial no. 94127990, filed on Aug. 17, 2005. All disclosure of the Taiwan application is incorporated herein by reference.

### BACKGROUND OF THE INVENTION

1. Field of the Invention

The present invention relates to an electronic product. More particularly, the present invention relates to an earphone.

2. Description of the Related Art

With the continuous advance in technologies, lighter and smaller electronic products are produced. As electronic products gets smaller and lighter, more and more people are carrying these miniaturized products such as radio or portable music player around. In addition, the popularization of personal digital products such as MP3 players, mobile phones, personal digital assistants (PDA) and notebook computers has rendered such equipment an indispensable part of our daily life. Furthermore, mobile phones that combine the function of a radio and an MP3 are already out in the market.

Since the aforesaid electronic products are all portable and can be used in public places, the user of these products would prefer listening to music or voice messages in private without disturbing other people. Therefore, earphone has become an indispensable accessory for most electronic products. Moreover, the earphone can provide a better acoustic transmission to the listener so that the user is able to hear clearly and discern the content of voice messages unlike the cluttered transmission of sound in air. In particular, the listening is little affect by outside activities such as exercising, driving, performing violent activities or moving around a noisy environment.

FIG. 1 is a sketch of a conventional earphone. As shown in FIG. 1, the outer casing 110 of the conventional earphone 100 is normally divided into two portions. A front portion 112 of the outer casing 110 is suitable for plugging into the external ear and a rear portion 114 is suitable for stationing an electric wire 120. However, the outer casing 110 is formed as an integrative unit. When the user accidentally tugs the electric wire 120 while the earphone 100 has already plugged into the ear, the pulling force will be immediately transmitted from the electric wire 120 to the rear portion 114 and then to the front portion 112 of the outer casing 110. As a result, the front portion 112 of the outer casing 110 may rub against the ear to cause great discomfort.

### SUMMARY OF THE INVENTION

Accordingly, at least one objective of the present invention is to provide an earphone suitable for increasing the level of comfort to the earphone user.

To achieve these and other advantages and in accordance with the purpose of the invention, as embodied and broadly described herein, the invention provides an earphone. The earphone mainly comprises a body, a wire-holder and an electric wire. The body of the earphone has a first pivoting part and the wire-holder has a second pivoting part. The electric wire passes smoothly through the wire-holder and is electrically connected to the body of the earphone. The second pivoting part is pivoted to the first pivoting part so that the wire-holder can be rotated with reference to the body.

In the aforesaid earphone, the first pivoting part comprises two pivoting axles and the second pivoting part comprises two pivoting holes, for example. Alternatively, the first pivoting part comprises two pivoting holes and the second pivoting part comprises two pivoting axles, for example.

In the aforesaid earphone, the wire-holder has a Y-shaped configuration, for example.

In the aforesaid earphone, the rotational axis of the wire-holder can be set in a direction substantially perpendicular to the electric wire running on the wire-holder. Furthermore, the body of the earphone includes a casing and a speaker unit. The casing has the aforementioned first pivoting part and a hole for the electric wire. The speaker unit is disposed inside the casing. The electric wire passes through the hole and connects electrically with the speaker unit. In addition, the earphone body may include an ear pad that encloses the casing outside the speaker unit.

In brief, the wire-holder and the body of the earphone in the present invention are connected through a pivot so that the wire-holder can rotate relative to the body. Hence, even if the wire-holder is subjected to the tug of an external force while the earphone is in use, the effect on the earphone body will be minimized. In other words, the earphone user is more comfortable wearing the earphone.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a sketch of a conventional earphone.

FIG. 2 is an explosion view of the major components of an earphone according to one embodiment of the present invention.

FIG. 3 is a side view of the earphone in FIG. 2 after assembly.

FIG. 4 is a perspective view of the earphone shown in FIG. 3.

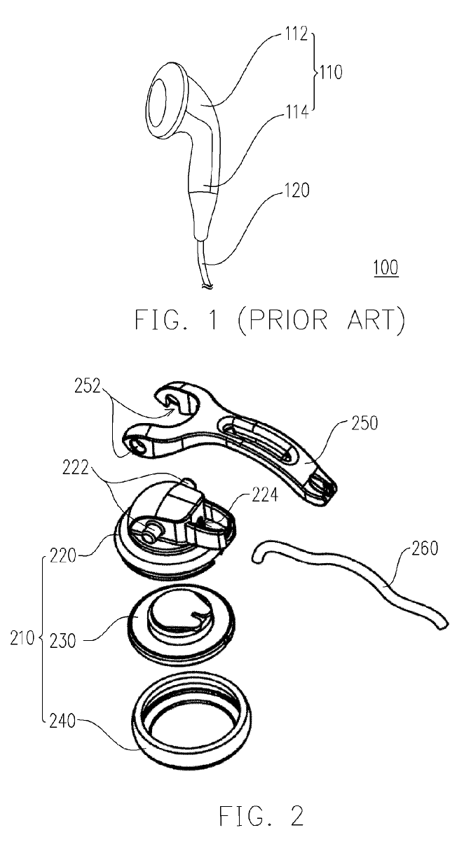

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

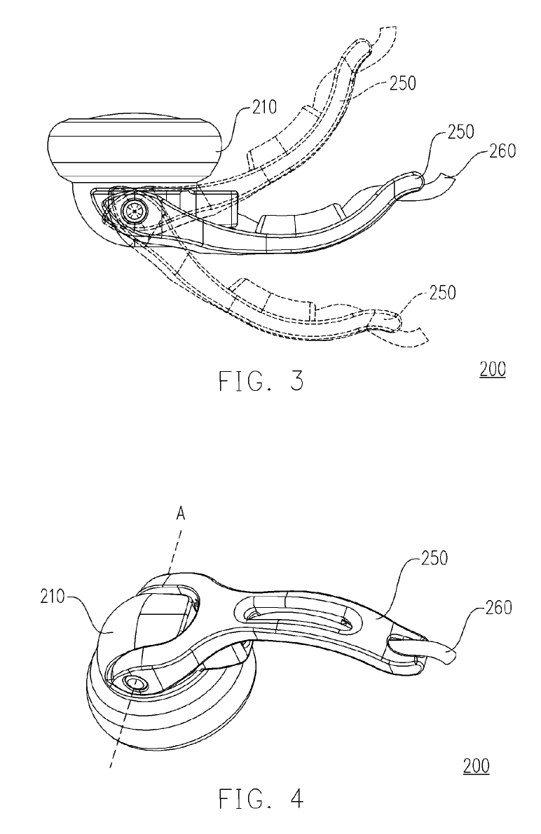

FIG. 2 is an explosion view of the major components of an earphone according to one embodiment of the present invention. FIG. 3 is a side view of the earphone in FIG. 2 after assembly. FIG. 4 is a perspective view of the earphone shown in FIG. 3.

As shown in FIGS. 2 and 3, the earphone 200 in the present embodiment mainly comprises an earphone body 210, a wire-holder 250 and an electric wire 260. The earphone body 210 has a first pivoting part 222 and the wire-holder 250 has a second pivoting part 252. The electric wire 260 passes smoothly through the wire-holder 250 and connects electrically with the earphone body 210. The second pivoting part 250 is pivoted to the first pivoting part 222 so that the second pivoting part 250 can be rotated with reference to the first pivoting part 222. In other words, the wire-holder 250 can be rotated with respect to the earphone body 210. With the wire-holder 250 and the earphone body 210 joined together through a rotatable connection, the wire-holder 250 can rotate relative to the earphone body 210 instead of directly transmitting a torque to the earphone body 210 inside the human ear when the wire-holder 250 is subjected to an external force applied in a direction perpendicular to the rotational axis A of the wire-holder 250 (shown in FIG. 3). Due to the minimization of rotation of the earphone body 210 with respect to the ear, the user is more comfortable wearing the earphone 200.

In the earphone 200 of the present embodiment, the first pivoting part 222 comprises two pivoting axles (or pins) and the second pivoting part 252 comprises two pivoting holes, for example. Thus, when the first pivoting part 222 is inserted into the second pivoting part 252, the wire-holder 250 is connected to the earphone body 210 and the two can rotate relative to each other along the rotational axis A. Furthermore, the rotational axis A in the wire-holder 250 is set in a direction substantially perpendicular to the electric wire 260 passing through the wire-holder 250. The dashed lines in FIG. 4 are used to indicate the rotation of the wire-holder 250. Obviously, the first pivoting part 222 can be pivoting holes and the second pivoting part 252 can be pivoting axes. In addition, there is no particular limitation on the number of first pivoting part 222 and the number of second pivoting part 252.

Furthermore, the wire-holder 250 in the present invention has a Y-shaped design. However, the shape of the wire-holder 250 is not limited as such. Moreover, the rotational angle between the wire-holder 250 and the earphone body 210 can be suitably constrained according to the actual requirements. Because the electric wire 260 pass smoothly through the wire-holder 250, the rotation of the wire-holder 250 will not be interfered by the electric wire 260. In other words, the wire-holder 250 is free to rotate.

The earphone body 210 further comprises a casing 220 and a speaker unit 230, for example. The casing 220 includes the aforesaid first pivoting part 222 and a hole 224 for an electric wire. The speaker unit 230 is disposed inside the casing 220. The speaker unit 230 comprises a speaker vibration system (not shown) and a magnetic circuit (not shown). Typically, the vibration of a film mounted on an electric coil (not shown) causes the speaker to emit sound. Obviously, the construction of the speaker unit 230 is not limited as such. The present invention can be applied to other kinds of speaker units. The electric wire 20 passes through the hole 224 and connects electrically with the speaker unit 230 for driving the speaker unit 230 to produce sound. The earphone body 210 may further include an ear pad 240 that encloses the casing 220 outside the speaker unit 230. Through the soft ear pad 240, user is more comfortable wearing the earphone 200.

In summary, the wire-holder and the body of the earphone in the present invention are connected through a first pivoting part and a second pivoting part so that the wire-holder can rotate relative to the body. Hence, even if the wire-holder is subjected to the tug of an external force while the earphone is in use, the effect on the earphone body will be minimized. In other words, the earphone user is more comfortable wearing the earphone.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An earphone, comprising:
a earphone body having a first pivoting part;
a wire-holder having a second pivoting part, wherein the second pivoting part is pivoted to the first pivoting part so that the wire-holder is suitable for rotating with reference to the earphone body; and
an electric wire passing smoothly through the wire-holder and connecting electrically with the earphone body.

2. The earphone of claim 1, wherein the first pivoting part comprises a pair of pivoting axles and the second pivoting part comprises a pair of pivoting holes.

3. The earphone of claim 1, wherein the first pivoting part comprises a pair of pivoting holes and the second pivoting part comprises a pair of pivoting axles.

4. The earphone of claim 1, wherein the wire-holder has an Y-shaped configuration.

5. The earphone of claim 1, wherein the rotation axis of the wire-holder is set in a direction substantially perpendicular to the electric wire running through the wire-holder.

6. The earphone of claim 1, wherein earphone body includes:
a casing having the first pivoting part and a hole for passing an electric wire; and
a speaker unit disposed inside the casing, wherein the electric wire passes through the hole and connects electrically with the speaker unit.

7. The earphone of claim 6, wherein the earphone body further includes an ear pad that encloses the casing outside the speaker unit.
